(19) United States
(12) Patent Application Publication
(10) Pub. No.: US 2026/0000581 A1
(43) Pub. Date: Jan. 1, 2026

(54) Pacifier Protector and Method

(71) Applicants: Alyson Rogg, Miami, FL (US); Andrea Evans, Miami, FL (US)

(72) Inventors: Alyson Rogg, Miami, FL (US); Andrea Evans, Miami, FL (US)

(21) Appl. No.: 19/256,062

(22) Filed: Jun. 30, 2025

Related U.S. Application Data
(60) Provisional application No. 63/666,018, filed on Jun. 28, 2024.

(51) Int. Cl. A61J 17/00

(52) U.S. Cl. CPC A61J 17/113; A61J 17/001

(57) ABSTRACT

Apparatus is provided for a protector for a pacifier that a parent or caregiver could choose for a child. The present disclosure teaches a pacifier protector that keeps a pacifier covered and clean, and also readily accessible, and allows the caregiver and child to continue using a pacifier of their choice. The apparatus of the present disclosure is easy to use and easy to clean. It may be used with other pacifier-retention systems that caregivers of the child may use or have. The apparatus encloses a pacifier, protecting it from getting dirty, and making it relatively easy to find. The present disclosure teaches methods of forming the pacifier protector.

### FIELD OF THE INVENTION

The presently disclosed subject matter relates to providing apparatus for pacifier protectors, and more particularly, to apparatus for a pacifier protector that covers a pacifier with a convenient and easily removed and replaced protector, which is easily washable, and can be used with existing pacifiers and pacifier retention systems, and methods of forming the same.

### BACKGROUND OF INVENTION

Pacifiers are popular and commonly used with young children. A wide range of pacifiers exist, and parents—and their children—tend to develop preferences for particular models. A common problem with pacifiers is that they often get dirty, as infants, babies, and toddlers tend to drop things or rub them on anything they encounter. Often, this is intentional on the part of the child, as a normal developmental stage involves throwing things to the ground or pushing them off of surfaces, to experiment with what happens next. Pacifiers can also become dirty if they are in a bag with multiple other objects and the general grit and lint that accumulates in backpacks and baby bags. Another problem with pacifiers is that they often are lost, as babies and toddlers tend to leave items and not retrieve them. Accordingly lost or dirty pacifiers are a common occurrence.

Prior art devices exist to help parents keep pacifiers clean and prevent them from getting lost. Examples include U.S. Pat. No. 9,271,900 to Badger et al. (the '900 patent). The '900 patent and other prior art require the parent or caregiver to get a new pacifier—or several, as caregivers often have multiple pacifiers stored in different bags and in different rooms. Non-patented products exist as well, such as the “Itzy Ritzy Soothe & Store Pacifier Clip and Storage Pouch” (as at https://www.amazon.com/Itzy-Ritzy-Pacifier-Wearable-Terracotta/dp/B0C832GXFJ/), the “mushie Silicone Pacifier Holder Case” (as at https://www.amazon.com/mushie-Silicone-Pacifier-Holder-Shifting/dp/B08MXQP6DH/), and the “Accmor Pacifier Case” (as at https://www.amazon.com/Accmor-Pacifier-Holder-Container-Transparent/dp/B09C5DZ5J7/r). These examples of non-patent literature contain the same shortcomings as patent-literature prior art: the foregoing products cannot be used with pacifier retention systems other than those they come with, or with retention systems at all, and some are hard to clean.

Finally, the prior art does not allow a user to use a pacifier of their, or a child's, choice, and keep the pacifier clean and secured, and also readily accessible.

### SUMMARY OF THE INVENTION

The present invention meets all these needs, by disclosing apparatus that provides a protector for any, or almost any, pacifier that a parent or caregiver could choose for a child. The present invention further addresses the problem of other pacifiers and cover systems, and pacifier retention systems, by providing a pacifier protector that keeps a pacifier covered and clean, and also readily accessible.

Further, the present invention introduces a product that allows parents and caregivers to use the product with existing pacifiers that they already own and that their child may already like, without needing to transition the child to a different pacifier to enable the use of a different pacifier cover system. The apparatus of the present disclosure is easy to use and easy to clean, distinguishing it from other pacifier covers and pacifier cover systems.

Finally, because the pacifier protector can enclose and hide a pacifier, the apparatus can assist with weaning, by hiding the pacifier from the child's view.

In one aspect, the present disclosure comprises a pacifier protector apparatus for protecting a pacifier.

In one aspect, the present disclosure comprises an apparatus for a pacifier protector.

In one aspect, the present disclosure comprises a method of forming a pacifier protector, the method comprising the following steps: forming the pacifier protector.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

In embodiments of the subject invention, the terms “substantially” and “approximately” are defined as at least close to (and can include) a given value or state, as understood by a person of ordinary skill in the art. In one embodiment, the terms “substantially” and “approximately” refer to ranges within 10%, preferably within 5%, more preferably within 1%, and most preferably within 0.1% of the given value or state being specified. Where ranges are provided, the foregoing applies to both the start and end of the range of values given.

In embodiments of the subject invention, the term “relatively” is defined as a comparison of a property, or the proportion of a property between two components.

### BRIEF DESCRIPTION OF THE DRAWINGS

The foregoing summary, as well as the following detailed description of various aspects, is better understood when read in conjunction with the appended drawings. For the purposes of illustration, the drawings show exemplary aspects; but the presently disclosed subject matter is not limited to the specific methods and instrumentalities disclosed. In the drawings, like reference characters generally refer to the same components or steps of the device throughout the different figures. In the following detailed description, various aspects of the present invention are described with reference to the following drawings, in which:

FIG. 1 shows a front and top perspective view of an aspect of the apparatus of the present invention.

FIG. 2 shows a front perspective view of an aspect of the apparatus of the present invention.

FIG. 3 shows a rear and bottom elevation view of an aspect of the apparatus of the present invention.

FIG. 4 shows a front elevation view of an aspect of the apparatus of the present invention.

FIG. 5 shows a first side elevation view of an aspect of the apparatus of the present invention.

FIG. 6 shows a rear elevation view of an aspect of the apparatus of the present invention.

FIG. 7 shows a second side elevation view of an aspect of the apparatus of the present invention.

FIG. 8 shows a top elevation view of an aspect of the apparatus of the present invention.

FIG. 9 shows a bottom elevation view of an aspect of the apparatus of the present invention.

FIG. 10 shows a cross-sectional view along the line marked A-A in FIG. 4.

FIG. 11 shows a cross-sectional view along the line marked B-B in FIG. 5.

### DETAILED DESCRIPTION OF THE DRAWINGS

The presently disclosed invention is described with specificity to meet statutory requirements. But, the description itself is not intended to limit the scope of this patent. Rather, the claimed invention might also be configured in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the apparatus of the present invention.

The present invention comprises a pacifier protector 100 for use with, i.e. that is compatible with, a pacifier, and more specifically, with any or almost any pacifier that a parent or caregiver could choose for a child. As is well known in the art, a pacifier may be used with, and is often used with, a pacifier retainer device which allows a user (typically, a caregiver of a child) to attach a pacifier to a strap or other device that may be held to the child's clothing or gear, such as a car seat or stroller or play seat or swaddling, so that the pacifier does not fall to the ground or floor. A pacifier retainer device is often though not necessarily a fabric or other durable strap, or may be an elastic or coiled strap, or other type of device suitable for the described purpose, with a clip to retain the device to the child's clothing or gear, and a clip or other means to retain the device to the pacifier.

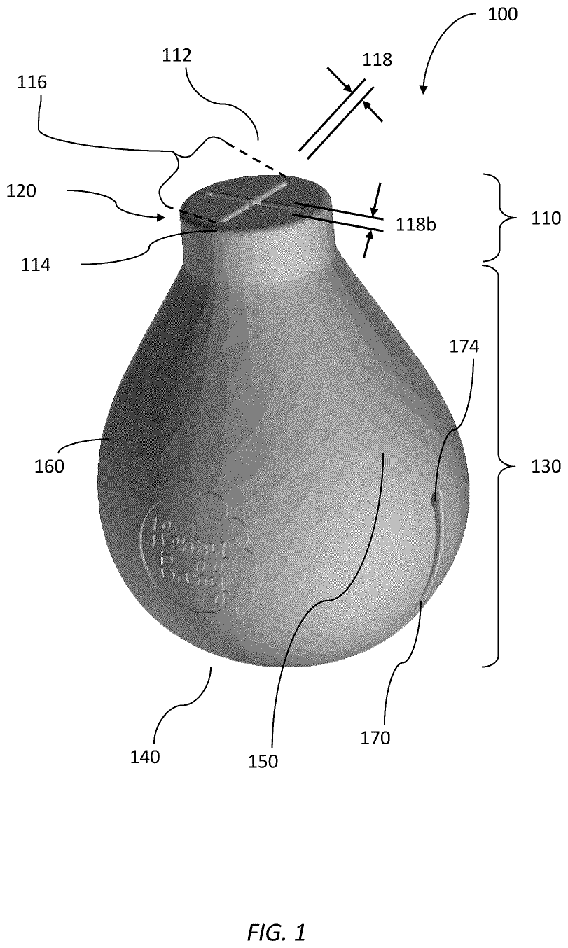

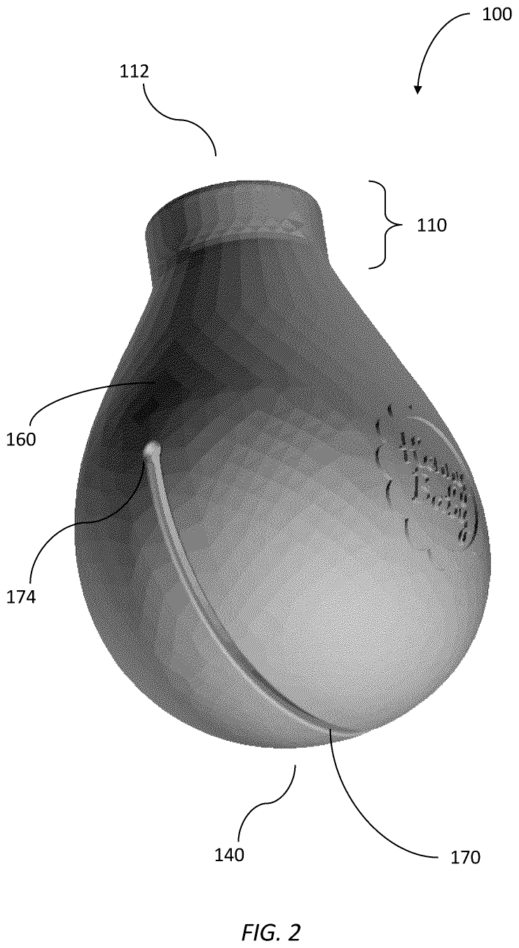

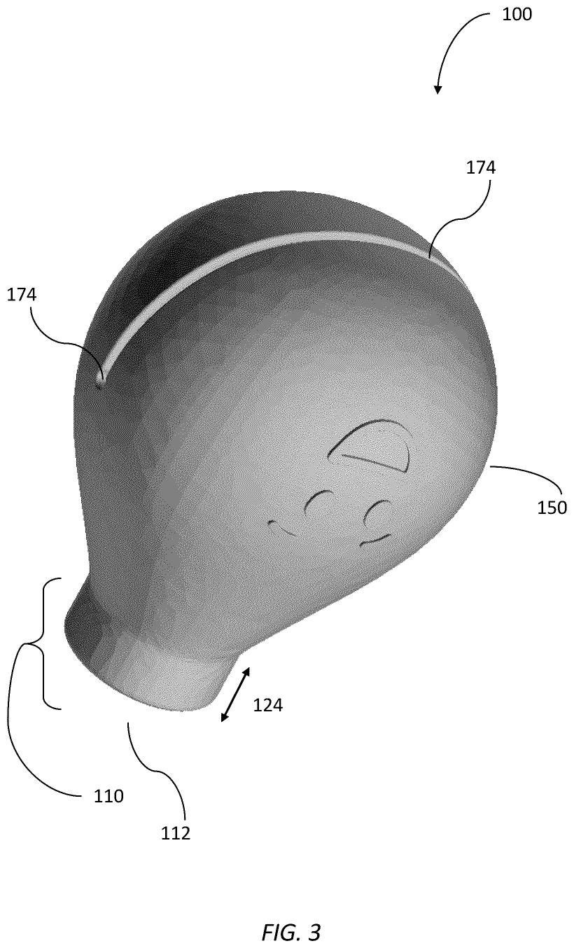

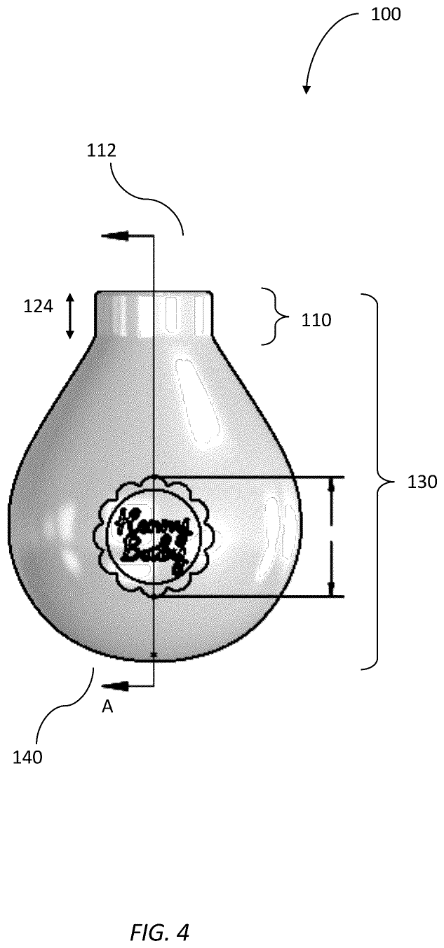

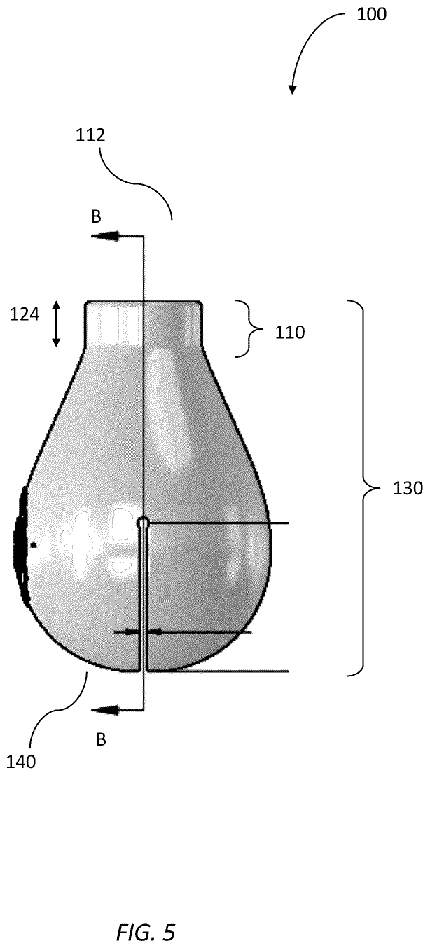

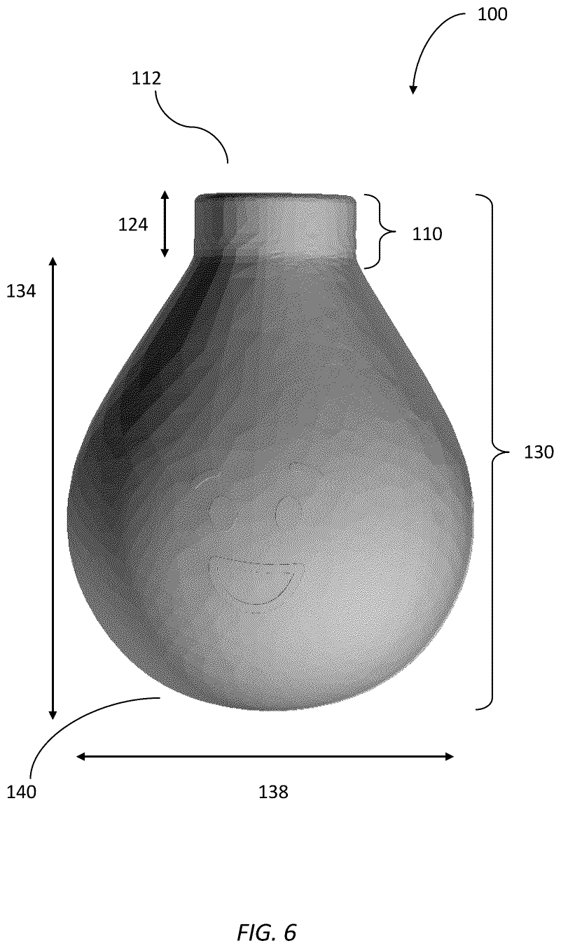

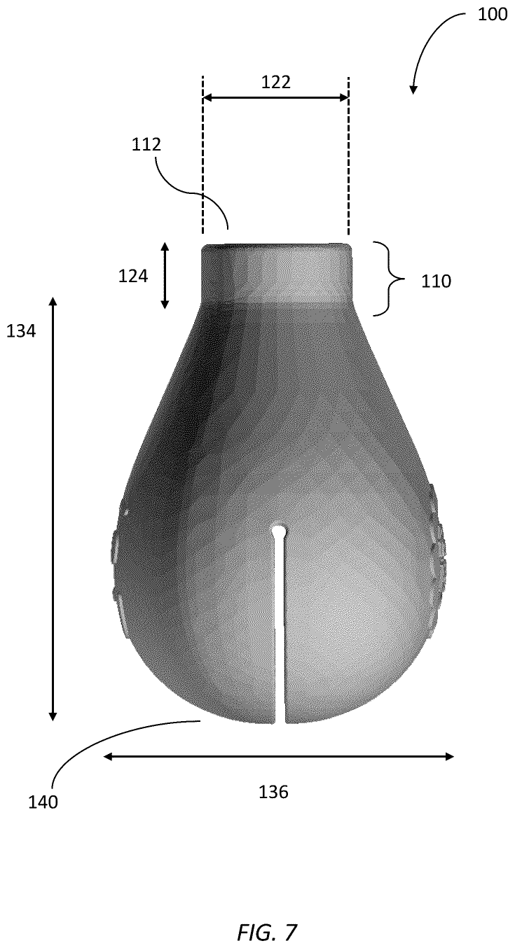

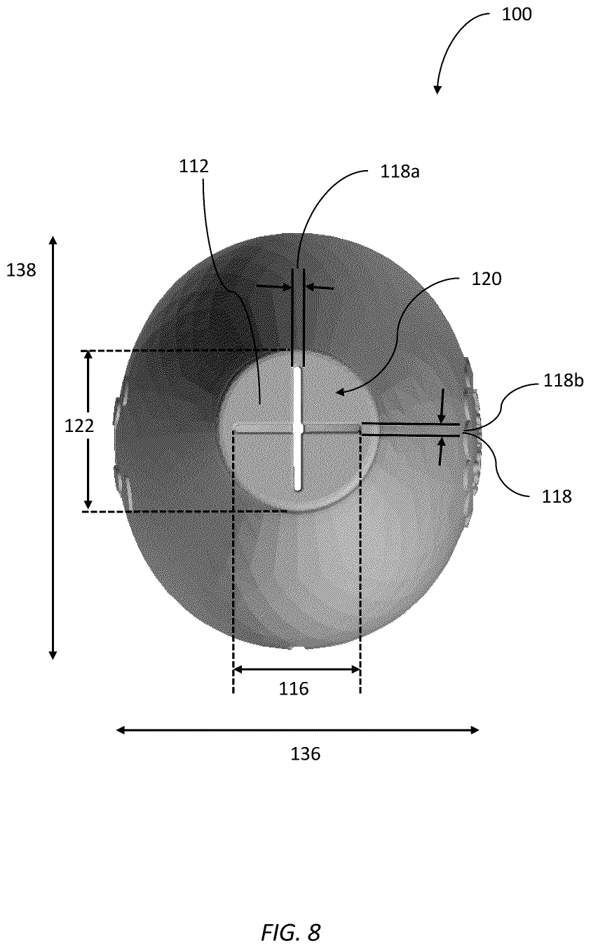

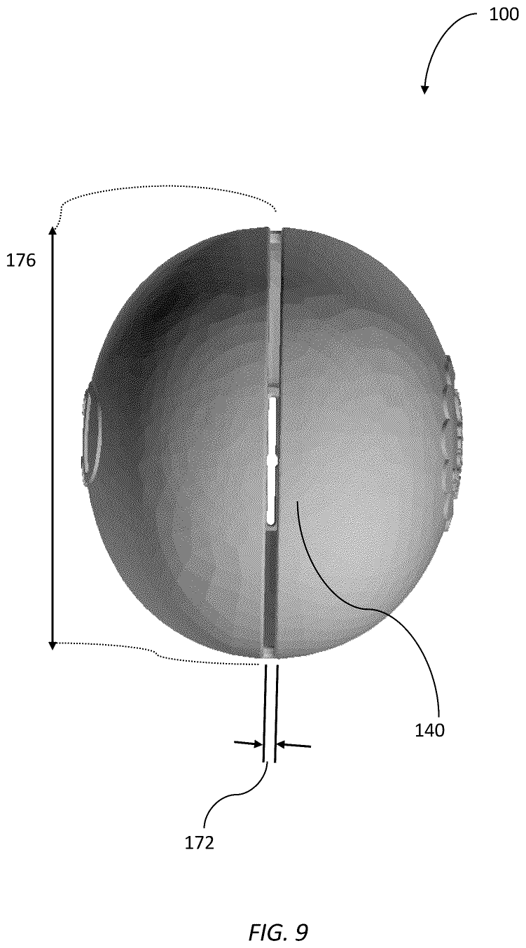

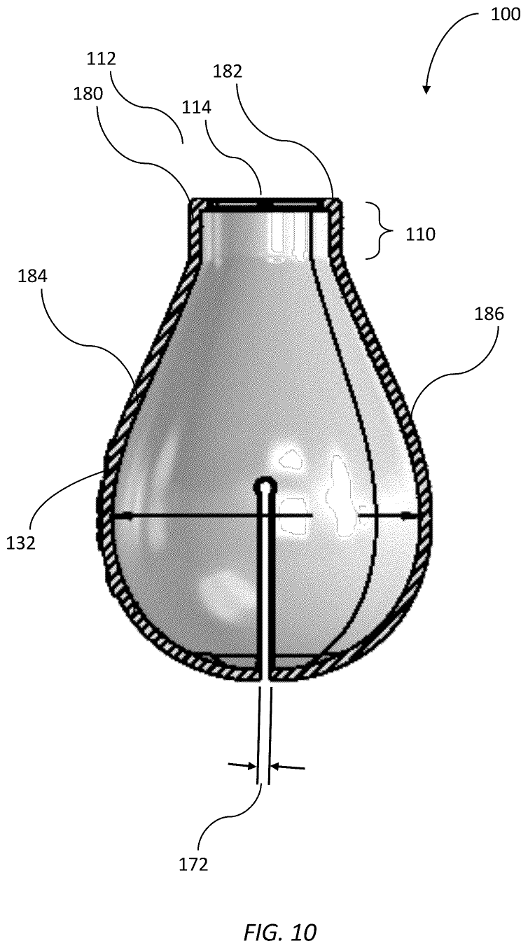

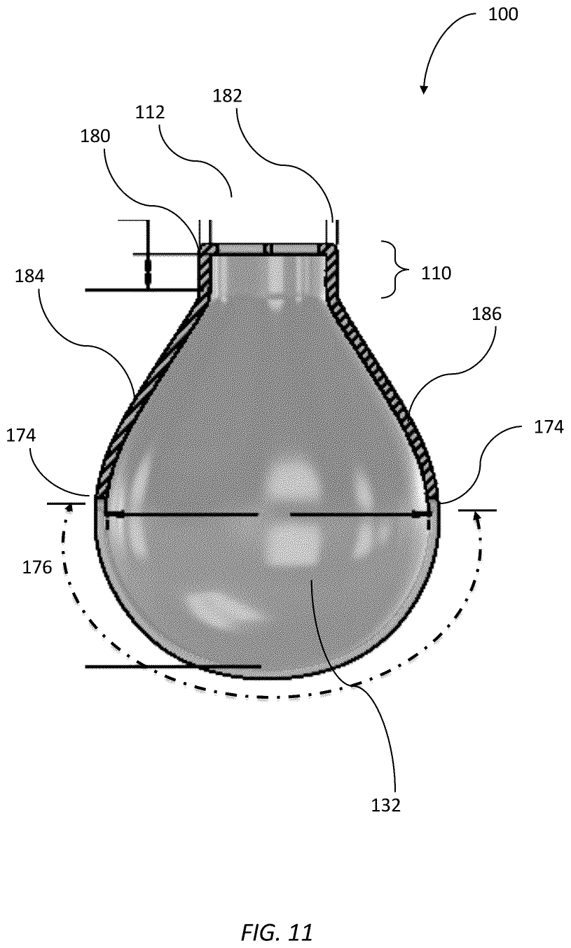

With reference to FIGS. 1, 2, 3, 4, 5, 6, 7, 8, 9, 10, and 11, the pacifier protector 100 of the present invention comprises a top region 110, the top region 110 having a top end 112, a body region 130, the body region 130 enclosing an interior volume 132 of the pacifier protector 100. The body region 130 comprises a body region height 134 (top to bottom), a body region depth 136 (from a first side of the pacifier protector 100 to a second side of the pacifier protector 100), and a body region width 138 (from slit end to slit end). The top region 110 comprises one or more top slits 114, wherein the one or more top slits 114 are an opening or openings in the top region 110 and advantageously in the top end 112. Each of the one or more top slits 114 comprise a top slit length 116 and a top slit opening width 118. In some aspects of the present disclosure, each of the one or more top slits 114 may comprise a top slit opening width 118 that is different for each of the one or more top slits 114, such that there may be a top slit opening width 118a, a top slit opening width 118b, and so on for any number of the one or more top slits 114. The one or more top slits 114 may be arranged in a top slits arrangement 120, which may be two such slits perpendicular to each other, or may be any other arrangement of the one or more top slits 114. The top region 110 comprises a top region external diameter 122 and a top region height 124.

The body region 130 comprises a body region bottom end 140, a first side region 150, a second side region 160, and one or more bottom slits 170. The first side region 150 and the second side region 160 are disposed advantageously as sides opposite each other and together comprise all or approximately all of the body region 130, and therefore of a material or materials comprising the body region 130. In some aspects of the present disclosure, the first side region 150 and the second side region 160 are separated from each other by the one or more bottom slits 170, in that the one or more bottom slits 170 is or are disposed as opening(s) in the body region 130 between the first side region 150 and the second side region 160. The one or more bottom slits 170 have a bottom slit opening width 172, have one or more bottom slit enlarged end regions 174, and have a bottom slit length 176. The bottom slit length 176 is advantageously sufficient to allow a user to open the body region 130 enough to allow a person to put a pacifier into the interior volume 132 of the pacifier protector 100 or to remove a pacifier from the interior volume 132. The bottom slit length 176 separates the first side region 150 and the second side region 160, allowing them to be elastically moved apart from each other and elastically return to near proximity to each other. The bottom slit opening width 172 is advantageously small enough that the pacifier cannot fall out of the pacifier protector 100, and small enough that other objects do not easily intrude into the pacifier protector 100. The end regions 174 function like hinges, to allow the first side region 150 and the second side region 160 to elastically move apart from and towards each other, and to prevent the material of the body region 130 from tearing as the sides are opened and closed repeatedly.

The body region 130 comprises at least one body region material 184, and the at least one body region material 184 comprises a body region material thickness 186, which body region material thickness 186 may be uniform throughout the body region 130 or may vary throughout the body region 130 as may be advantageous for durability, flexibility, and the ability to allow the user to insert and remove a pacifier from the interior volume 132 repeatedly without damaging the pacifier protector 100.

The top region 110 comprises at least one top region material 180, and the at least one top region material 180 comprises a top region material thickness 182, which top region material thickness 182 may be uniform throughout the top region 110 or may vary throughout the top region 110 as may be advantageous for durability, flexibility, and the ability to allow the user to insert and remove a pacifier retainer device from the interior volume 132 through the top region 110 repeatedly without damaging the pacifier protector 100.

In using the pacifier protector 100, a user may advantageously insert an end, or part or all, of a pacifier retainer device through the one or more top slits 114 and thus into the space of the top region 110 and the interior volume 132. Alternatively, the user may insert part or all of a pacifier retainer device through the one or more bottom slits 170 and into the interior volume 132, and then through the space of the top region 110 and then through the one or more top slits 114. In whichever order this is achieved, the user then has, advantageously, one end of the pacifier retainer device in the interior volume 132, and one end of the pacifier retainer device outside of the pacifier protector 100. The end of the pacifier retainer device that is outside may be affixed to the child's clothing or gear, as will be apparent to one of skill in the art. The end of the pacifier retainer device that is in the interior volume 132 may be affixed to the pacifier, if it was not already so attached. By passing the pacifier retainer device through the one or more top slits 114, the pacifier protector 100 may then slide along the pacifier retainer device, with or without the pacifier inside of the pacifier protector 100. The pacifier may be inserted into the interior volume 132 and removed from the interior volume 132, such insertion and removal being repeatable and reversible, so that the pacifier may be used and may be kept clean or approximately clean when not in use, by keeping the pacifier nearby, not allowing it fall onto the floor or ground, and keeping most dust and dirt and other potential contaminants off of the pacifier.

The pacifier protector 100 is advantageously made of food-grade and non-toxic materials, including but not limited to silicone, so that the pacifier protector 100 is hypoallergenic and free from harmful chemicals. Advantageously, the shape of the pacifier protector 100 makes it easy for the user to access the pacifier and to hide the pacifier when the user doesn't want the child to see it or use it. By being compatible with existing pacifier retainer devices, the pacifier protector 100 of the present disclosure is hard to lose. Another goal of the present disclosure is to make a pacifier protector 100 that is easy to clean by hand or in an automatic dishwasher, and which is safe to clean by those or other means.

The pacifier protector 100 may be formed of one piece of material, or more as may be advantageous. The pacifier protector 100 may be formed by shaping the material into the components and elements as described herein.

Certain aspects of the present invention were described above. From the foregoing it will be seen that this invention is one well adapted to attain all the ends and objects set forth above, together with other advantages, which are obvious in and inherent to the inventive apparatus disclosed herein. It will be understood that certain features and sub-combinations are of utility and may be employed without reference to other features and sub-combinations. It is expressly noted that the present invention is not limited to those aspects described above, but rather the intention is that additions and modifications to what was expressly described herein are also included within the scope of the invention. Moreover, it is to be understood that the features of the various aspects described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A pacifier protector comprising:
a top region comprising a top end, a top region external diameter, and a top region height;
a body region extending from the top region, the body region enclosing an interior volume and comprising a body region height, a body region depth, and a body region width; and
one or more top slits formed in the top region, each of the one or more top slits having a top slit length and a top slit opening width;
wherein the one or more top slits are arranged in a top slits arrangement in the top end of the top region.

2. The pacifier protector of claim 1, wherein the body region has a body region height extending from a top end to a bottom end, a body region depth extending from a first side of the pacifier protector to a second side of the pacifier protector, and a body region width extending from a first slit end to a second slit end.

3. The pacifier protector of claim 1, wherein each of the one or more top slits comprises a top slit opening width that is different for each of the one or more top slits.

4. The pacifier protector of claim 1, wherein the top slits arrangement comprises two top slits arranged perpendicularly to one another.

5. The pacifier protector of claim 1, wherein the top slits arrangement comprises more than two slits.

6. The pacifier protector of claim 1, wherein the body region comprises a body region bottom end, a first side region, and a second side region.

7. The pacifier protector of claim 6, wherein the first side region and the second side region are disposed on opposite sides of the body region and together comprise approximately all of the body region.

8. The pacifier protector of claim 6, further comprising one or more bottom slits disposed between the first side region and the second side region.

9. The pacifier protector of claim 8, wherein each of the one or more bottom slits comprises a bottom slit length, a bottom slit opening width, and one or more bottom slit enlarged end regions.

10. The pacifier protector of claim 9, wherein the bottom slit length is sufficient to allow the first side region and the second side region to be elastically moved apart from each other to allow insertion or removal of a pacifier into or from the interior volume of the body region.

11. The pacifier protector of claim 9, wherein the bottom slit opening width is sufficiently small to prevent a pacifier from falling out of the body region and to prevent intrusion of other objects.

12. The pacifier protector of claim 9, wherein the one or more bottom slit enlarged end regions function as hinges to allow the first side region and the second side region to elastically move apart from and towards each other without tearing the body region.

13. The pacifier protector of claim 1, wherein the body region comprises at least one body region material having a body region material thickness, the body region material thickness being selected to enhance durability, flexibility, and repeated use during insertion and removal of a pacifier from the interior volume, and the at least one body region material being sufficiently flexible to allow repeated elastic movement of the body region without damage to the pacifier protector.

14. The pacifier protector of claim 1, wherein the top region comprises at least one top region material having a top region material thickness, the top region material thickness being selected to enhance durability, flexibility, and repeated use during insertion and removal of a pacifier retainer device through the top region, and the at least one top region material being sufficiently flexible to allow repeated elastic movement of the top region without damage to the pacifier protector.

15. The pacifier protector of claim 1, wherein the pacifier protector is made of one or more food-grade and non-toxic materials.

16. The pacifier protector of claim 1, wherein the pacifier protector is formed of one piece of material.

17. The pacifier protector of claim 1, wherein the pacifier protector is formed of more than one piece of material.

18. A method of using a pacifier protector, comprising:
inserting a portion of a pacifier retainer device through one or more top slits formed in a top region of the pacifier protector and into an interior volume of the pacifier protector, such that a first end of the pacifier retainer device remains outside the pacifier protector and a second end of the pacifier retainer device is positioned within the interior volume or external to or below the interior volume;
affixing the first end of the pacifier retainer device to an object including but not limited to a child's clothing or gear; and
affixing the second end of the pacifier retainer device to a pacifier that is in the interior volume of the pacifier protector or external to or below the interior volume of the pacifier protector.

19. The method of claim 18, further comprising inserting at least part of the pacifier retainer device into the interior volume through one or more bottom slits of a body region of the pacifier protector before inserting it through the one or more top slits.

20. A method of forming a pacifier protector, comprising:
forming a body region from at least one body region material, the body region defining an interior volume and having a body region height extending from a top end to a bottom end, a body region depth extending from a first side to a second side, and a body region width extending from a first slit end to a second slit end;
forming a top region at a top end of the body region, the top region comprising a top end and a top region height; and
forming one or more top slits in the top region, each of the one or more top slits having a top slit length and a top slit opening width, and being arranged in a top slits arrangement at the top end of the top region.
